(19) United States
(12) Patent Application Publication
(10) Pub. No.: US 2024/0401971 A1
(43) Pub. Date: Dec. 5, 2024

(54) MAP-BASED CONSISTENT AND EFFICIENT FILTERING ALGORITHM FOR VISUAL INERTIAL POSITIONING

(71) Applicant: Zhejiang University, Hangzhou (CN)

(72) Inventors: Yue Wang, Hangzhou (CN); Zhuqing Zhang, Hangzhou (CN); Jun Wu, Hangzhou (CN); Rong Xiong, Hangzhou (CN)

(21) Appl. No.: 18/785,121

(22) Filed: Jul. 26, 2024

Related U.S. Application Data
(63) Continuation-in-part of application No. PCT/CN2023/072749, filed on Jan. 17, 2023.

(30) Foreign Application Priority Data
Apr. 27, 2022 (CN) 202210458943.3

(51) Int. Cl. G01C 21/00; G06T 7/246; G06V 10/44; G06V 10/74

(52) U.S. Cl. CPC G01C 21/3848; G06T 7/246; G06V 10/44; G06V 10/761

(57) ABSTRACT

A system includes three modules: a local odometry module, a map feature matching module, and a map-based positioning module, where the local odometry module is configured to receive data of a camera and an inertial measurement unit (IMU); the map feature matching module is configured to detect a similarity between a scene observed by the camera at a current moment and a pre-built map scene, and obtain a feature matching pair of an image feature at the current moment and a map feature; and the map-based positioning module is configured to receive an output amount of the local odometry and the feature matching pair. In the present invention, a maintained odometry-related variable and the relative transformation between a local odometry reference system and a pre-built map reference system are expressed in a Lie group, such that a new invariant Kalman filter (IKF) algorithm is obtained.

### CROSS REFERENCE TO RELATED APPLICATIONS

The present application is a Continuation-In-Part Application of PCT Application No. PCT/CN2023/072749 filed on Jan. 17, 2023, which claims the benefit of Chinese Patent Application No. 202210458943.3 filed on Apr. 27, 2022. All the above are hereby incorporated by reference in their entirety.

### TECHNICAL FIELD

The present invention relates to robot positioning technology, and specifically to a map-based consistent and efficient filtering algorithm for visual inertial positioning.

### BACKGROUND

Positioning technology is an essential basic module for intelligent robots. In recent years, cameras and inertial measurement units (IMU) have been widely used in positioning technology, spawning a large number of excellent visual inertial odometry (VIO) algorithms. However, the positioning accuracy of VIO will inevitably drift as the run time of the algorithm elapses. This requires the introduction of a pre-built map to eliminate a cumulative error. When the positioning algorithm fuses pre-built map information, the system needs to ensure consistent and effective fusion of the map information in order to effectively use the map information to eliminate the accumulated error of the odometry.

Frameworks of current positioning algorithms are divided into two types. One type is to initialize the relative transformation between the local odometry reference system and the pre-built map reference system, and then perform real-time positioning in the map reference system. The other type is to simultaneously maintain the local odometry and the relative transformation between the local odometry reference system and the pre-built map reference system, thereby indirectly obtaining the position in the map reference system. The limitation of the first type of algorithm is that for visual inertial positioning, the pre-built map needs to be in the inertial system, which limits the application of the positioning algorithm. For the second type of algorithm, although there is no limitation of the first type of algorithm, potential problems in this type of framework may destroy the observability of the system and make the originally unobservable information observable, thereby introducing false observable information, which reduces the positioning accuracy and even causes the algorithm to diverge.

In addition, due to limitations of computational efficiency or algorithm framework, a vast majority of algorithms do not consider the uncertainty of the map and believe that the map is absolutely accurate. This will make the positioning algorithms rely too much on the inaccurate map, greatly reducing the positioning effect. Even though some algorithms consider the uncertainty of the map in the above framework, the algorithms destroy the observability of the system and make the originally unobservable information observable, thereby introducing false observable information, which reduces the positioning accuracy and even causes the algorithm to diverge.

How to ensure the correct observability of the system while considering the uncertainty of the map, thereby improving the accuracy and reliability of the map-based positioning algorithm is a problem that needs to be solved. In addition, it is further necessary to ensure that the computational load of the system is kept at a low level.

### SUMMARY

To overcome the shortcomings of the existing technology, the present invention proposes a filtering-based positioning algorithm and a visual inertial positioning technology based on a pre-built visual map. The proposed visual inertial positioning technology is implemented based on a consistent and efficient filtering algorithm. The present invention is implemented through the following technical solution:

The present invention discloses a map-based consistent and efficient filtering algorithm for visual inertial positioning, where the algorithm is implemented through the following system, and the system includes three modules: a local odometry module, a map feature matching module, and a map-based positioning module, where the local odometry module is configured to receive data of a camera and an IMU, obtain a state of the system in a local reference system in real time, and obtain values of corresponding state variables and covariance of the values; the map feature matching module is configured to detect a similarity between a scene observed by the camera at a current moment and a pre-built map scene, and obtain a feature matching pair of an image feature at the current moment and a map feature; and the map-based positioning module is configured to receive an output amount of the local odometry and the feature matching pair, obtain an updated state of the local odometry and a relative transformation (augmentation variable) between the local reference system and a map reference system, and then calculate a state of a robot in the map reference system.

As a further improvement, in the present invention, the local odometry module includes the IMU, a state propagation module in signal connection to the IMU, the camera, a feature tracking module in signal connection to the camera, and a Multi-State Observability Constraint-Schmidt-Invariant Kalman Filter (MSOC-S-IKF) state update module based on local feature observation in signal connection to the state propagation module and the feature tracking module.

As a further improvement, in the present invention, the IMU is configured to provide real-time rotation angular velocity and linear acceleration for the system; the state propagation module is configured to receive the rotation angular velocity and the linear acceleration that are provided by the IMU, propagate the state of the system from a previous moment to the current moment by using the quantities, and obtain state variables predicted at the current moment and a covariance; and transmit signals of the obtained state variables and covariance to the MSOC-S-IKF state update module based on local feature observation; the feature tracking module is configured to track positions of feature points in an image at the previous moment in an image at the current moment, obtain tracked feature points in the image at the current moment, and transmit signals of the obtained feature points to the MSOC-S-IKF state update module based on local feature observation; and the MSOC-S-IKF state update module based on local feature observation is configured to calculate, through inputted feature point information combined with the inputted predicted state variables and covariance, an observation error through a reprojection error, and update the state variables and the covariance using an invariant Kalman filter (IKF) combined with a multi-state constraint (MS) proposed by the invention.

As a further improvement, in the present invention, the state variables and the covariance corresponding to the state variables are required to include the following variables:
1) the state of the system body at the current moment t: including a pose composed of a rotation matrix ^{L}R_{I}_{ₜ} and a translation vector ^{L}p_{I}_{ₜ}, and a linear velocity ^{L}v_{I}_{ₜ};
2) feature points ^{L}p_{f}_{ₜ} in the local reference system;
3) biases [symbol] and [symbol] of an angular velocity and a linear acceleration of an IMU sensor, to constitute a variable Bₜ=[b_{g}_{ₜ}^{⋅}bₐ_{ₜ}^{⋅}]^{⋅};
4) a body pose [symbol] [symbol] { [symbol] , . . . , [symbol] } of the system at past s moments, where s is a size of a set sliding window, and the pose {X_{CP}_{ᵢ}} is composed of a rotation matrix ^{L}R_{I}_{ᵢ} representing an orientation and a vector ^{L}p_{I}_{ᵢ} representing a position; and X_{Clone}_{ₜ} is used for the MSOC-S-IKF state update module based on local feature observation;
5) a pose transformation ^{L}T_{G} (referred to as an augmentation variable) between the local odometry reference system and the map reference system, composed of a rotation matrix ^{L}R_{G} representing an orientation and a vector ^{L}p_{G} representing a position, where the variable is added to the state variables through a module for initializing an augmentation variable using Perspective-n-Point (PnP) in the map-based positioning module; and
6) a pose [symbol] [symbol] { [symbol] , . . . , [symbol] } in a map key frame, where the pose {X_{KF}_{ᵢ}_{,t}} is composed of a rotation matrix ^{G}R_{KF}_{ᵢ}_{,t} representing an orientation and a vector ^{G}p_{KF}_{ᵢ}_{,t} representing a position, and the variable is added to the state variables through a module for adding a pose in a map key frame to a system state in the map-based positioning module.

As a further improvement, in the present invention, the state variables 1), 2), and 5) are represented together on a new Lie group space SE_{2+K}^{M}(3), the state variables 4) and 6) are represented in a Lie group space SE(3), the state variable 3) is represented in a Euclidean vector space, and a specific definition of SE_{2+K}^{M}(3) is:

$${SE}_{2 + K}^{M} ( 3 ) {=}^{△} [ \begin{matrix} & {0}_{( 5 + K + M ) \times ( 3 M )} \\ {0}_{( 5 + K + M ) \times ( 3 M )}^{⊤} & \end{matrix} ] ,$$

$$∈ {SE}_{2 + K + M} ( 3 ) , {=}^{△} diag ( {R}_{1} , … , {R}_{M} ) ,$$

$${R}_{i} ∈ SO ( 3 ) , i = 1 , … , M \}$$

where diag(.) represents a diagonal block matrix, SO(3) is defined as: SO(3) [symbol] {R∈ [symbol] RR^{T}=I,det(R)=1}, det(.) represents a determinant of a matrix, SE_{2+K}(3) is defined as:

$${SE}_{2 + K} ( 3 ) {=}^{△} \{ γ = [ \begin{matrix}R & t \\ {0}_{( 2 + K ) \times 3} & {I}_{( 2 + K ) \times ( 2 + K )}\end{matrix} ] ∈ \vert R ∈ SO ( 3 ) , t ∈ \}$$

a Lie algebra [symbol] (3) corresponding to the Lie group SE_{2+K}^{M}(3) is defined as:

$${\text{?}}_{2 + K}^{M} ( 3 ) {=}^{△} \{ ℒ \text{?} ( ϕ ) , ϕ = {[ \begin{matrix}{θ}_{0}^{⊤} & {ϕ}_{1}^{⊤} & … & {ϕ}_{2 + K + M}^{⊤} & {θ}_{1}^{⊤} & … & {θ}_{M}^{⊤}\end{matrix} ]}^{⊤} ∈ \}$$

$$ℒ \text{?} ( ϕ ) = {ϕ}^{λ} {=}^{△} [ \text{} \begin{matrix}( {θ}_{0} ) \text{?} & {ϕ}_{1} … {ϕ}_{2 + K + M} & {0}_{3 \times 3 M} \\ {0}_{( 2 + K + M ) \times 3} & {0}_{2 + K + M} & {0}_{( 2 + K + M ) \times ( 3 M )} \\ {0}_{3 M \times 3} & {0}_{3 M \times ( 2 + K + M )} & Θ\end{matrix} \text{} ]$$

$$Θ {=}^{△} diag ( {( {θ}_{1} )}_{\times } , … , {( {θ}_{M} )}_{\times } ) ;$$

$$\text{?} \text{indicates text missing or illegible when filed}$$

based on the definitions of SE_{2+K}^{M}(3) and se_{2+K}^{M}(3), states composed of the states 1), 2), and 5) are represented as:

$$X \text{?} = [ \begin{matrix}{}^{L} R \text{?} & {}^{L} v \text{?} & {}^{L} p \text{?} & {}^{L} p \text{?} & {}^{L} p \text{?} & {0}_{3} \\ {0}_{1 \times 3} & 1 & 0 & 0 & 0 & {0}_{3} \\ {0}_{1 \times 3} & 0 & 1 & 0 & 0 & {0}_{3} \\ {0}_{1 \times 3} & 0 & 0 & 1 & 0 & {0}_{3} \\ {0}_{1 \times 3} & 0 & 0 & 0 & 1 & {0}_{3} \\ {0}_{3} & {0}_{3 \times 1} & {0}_{3 \times 1} & {0}_{3 \times 1} & {0}_{3 \times 1} & {}^{L} R \text{?}\end{matrix} ]$$

$$\text{?} \text{indicates text missing or illegible when filed}$$

corresponding state errors are defined as:

$$ξ \text{?} = \tilde{θ} \text{?}$$

$$ξ \text{?} = {}^{L} v \text{?} - ( {I}_{3} + {( \tilde{θ} \text{?} )}_{\times } ) {}^{L} v \text{?}$$

$$ξ \text{?} = {}^{L} p \text{?} - ( {I}_{3} + {( \tilde{θ} \text{?} )}_{\times } ) {}^{L} p \text{?}$$

$$ξ \text{?} = {}^{L} p \text{?} - ( {I}_{3} + {( \tilde{θ} \text{?} )}_{\times } ) {}^{L} p \text{?}$$

$$ξ \text{?} = {}^{L} p \text{?} - ( {I}_{3} + {( \tilde{θ} \text{?} )}_{\times } ) {}^{L} p \text{?}$$

$$ξ \text{?} = \tilde{θ} \text{?}$$

$$\text{?} \text{indicates text missing or illegible when filed}$$

an error of the state 3) is defined as:

$$ξ \text{?} = {[ \begin{matrix}{( \hat{b} \text{?} - b \text{?} )}^{⊤} & {( \hat{b} \text{?} - b \text{?} )}^{⊤}\end{matrix} ]}^{⊤}$$

$$\text{?} \text{indicates text missing or illegible when filed}$$

an error of a pose {X_{CP}_{ᵢ}} corresponding to the state 4) is defined as:

$$ξ \text{?} = \tilde{θ} \text{?}$$

$$ξ \text{?} = p \text{?} - ( {I}_{3} + {( \tilde{θ} \text{?} )}_{\times } ) p \text{?}$$

$$\text{?} \text{indicates text missing or illegible when filed}$$

an error of a pose {X_{KF}_{ᵢ}_{,t}} corresponding to the state 6) is defined as:

$$ξ \text{?} = θ \text{?}$$

$$ξ \text{?} = {}^{G} p \text{?} - ( {I}_{3} + {( θ \text{?} )}_{\times } ) {}^{G} p \text{?}$$

$$\text{?} \text{indicates text missing or illegible when filed}$$

θ in the above equations represents an error of a corresponding rotation matrix R, and is defined as: θ=log(RR⁻¹), and log maps the Lie group SO(3) to a corresponding Lie algebra so(3); and \hat{⋅} in the above equations represents an estimated value.

As a further improvement, in the present invention, when the state propagation module and the MSOC-S-IKF state update module based on local feature observation solve a Jacobian matrix of a motion equation or an observation equation with respect to a state variable error, the state error used is defined as above.

As a further improvement, in the present invention, the MSOC-S-IKF state update module based on local feature observation completes state update through the following equations:

$$S \text{?} = H \text{?} P \text{?} H \text{?} + W \text{?}$$

$$K \text{?} {=}^{△} [ \begin{matrix}K \text{?} \\ K \text{?} \\ K \text{?}\end{matrix} ] = P \text{?} H \text{?} S \text{?}$$

$$X \text{?} = [ \begin{matrix}X \text{?} \\ B \text{?} \\ X \text{?}\end{matrix} ] [ \begin{matrix}exp ( K \text{?} r \text{?} ) X \text{?} \\ B \text{?} + K \text{?} r \text{?} \\ exp ( K \text{?} r \text{?} ) X \text{?}\end{matrix} ]$$

$$P \text{?} = P \text{?} - K \text{?} H \text{?} P \text{?}$$

$$\text{?} \text{indicates text missing or illegible when filed}$$

where Hₜ is a Jacobian matrix of an observation equation with respect to a state error, Wₜ is a variance of observation noise, rₜ is an “innovation term” derived from an observation residual, exp( ) is an exponential mapping corresponding to a corresponding Lie group, P_{t|t-1} is a variance of an output of the state propagation module, and [symbol] and P_{t|t} are respectively state variables and a corresponding covariance updated by the MSOC-S-IKF state update module based on local feature observation.

As a further improvement, in the present invention, the map feature matching module is configured to obtain, through information about the current camera and a map, map feature points obtained by the current camera through matching and a map key frame in which the map feature points are observable, namely, a feature pair and a map key frame that match, where signals of the feature pair and the map key frame that match are transmitted to the map-based positioning module.

As a further improvement, in the present invention, the map-based positioning module includes the following modules:
a module for determining whether there is a feature matching pair, a module for determining whether an augmentation variable is initialized, the module for initializing an augmentation variable using PnP, a module for adding an augmentation variable to a system state, the module for adding a pose in a map key frame to a system state, an MSOC-S-IKF state update module based on map feature observation, and a module for outputting an odometry state and an augmentation variable; the module for determining whether there is a feature matching pair is configured to receive information from the map feature matching module, and determine whether a map key frame and a corresponding feature matching pair that match a current frame are provided; the module for determining whether an augmentation variable is initialized is configured to determine whether a relative pose (namely, an augmentation variable) between the map reference system and the local odometry reference system has been initialized; the module for initializing an augmentation variable using PnP is configured to calculate a relative pose between the map reference system and the local odometry reference system, to obtain a value of the augmentation variable and a corresponding covariance; the module for adding an augmentation variable to a system state is configured to add the augmentation variable to variables maintained by the system, where the augmentation variable is updatable in real time through the subsequent MSOC-S-IKF state update module based on map feature observation; the module for adding a pose in a map key frame to a system state is configured to add the pose in the map key frame and the covariance to the state variables of the system and the covariance of the system, to naturally take into account uncertainty of the map and improve consistency of the system; and the MSOC-S-IKF state update module based on map feature observation uses the information about the map to update the state variables of the system while satisfying 1) considering the uncertainty of the map, 2) maintaining correct observability of the system, and 3) requiring a low amount of calculations for the system, to obtain a more precise odometry state and augmentation variable and then obtain a more precise pose of the robot in the map reference system.

As a further improvement, in the present invention, the module for determining whether there is a feature matching pair is configured to determine whether the map feature matching module has an output, where if there is an output, indicating that there is a feature matching pair between the current frame and a map frame, a subsequent map-based positioning-related process is performed; or if there is no output, indicating that there is no feature matching pair between the current frame and a map frame, an odometry state and an augmentation variable are outputted directly (if the augmentation variable has been initialized) without performing MSOC-S-IKF state update based on map feature observation; the module for determining whether an augmentation variable is initialized is configured to determine whether the system is required to initialize the augmentation variable (namely, the relative pose between the local odometry reference system and the map reference system), where if the map feature matching module has outputted a feature pair and a map key frame that match and the augmentation variable has been initialized, the map key frame is added directly to the system state, and the feature pair and the map key frame that match are further used for the subsequent MSOC-S-IKF state update module based on map feature observation; or if the map feature matching module has outputted a feature pair and a map key frame that match, but the augmentation variable has not been initialized, the feature pair and the map key frame that match are used for the module for initializing an augmentation variable using PnP; the module for initializing an augmentation variable using PnP is configured to solve a relative pose between the map key frame and the current frame of the camera by receiving the feature pair and the map key frame that match outputted by the map feature matching module and using a PnP algorithm, and solve the relative pose (the augmentation variable) between the local odometry reference system and the map reference system by using the pose in the map key frame and a pose of the robot in the local odometry reference system at the current moment, to complete the initialization; the module for adding an augmentation variable to a system state is configured to add the initialized augmentation variable and covariance thereof to the system state, to maintain and update the augmentation variable in real time, so that the estimation accuracy gradually improves and becomes stable; the module for adding a pose in a map key frame to a system state is specifically as follows: when there is a feature matching pair between the map key frame and the current frame, and the augmentation variable has been initialized, the map key frame is directly added to the system state; or when there is a feature matching pair between the map key frame and the current frame, and the augmentation variable has not been initialized, the initialization is completed through the module for initializing an augmentation variable using PnP, and then a signal of the pose in the map key frame used for initialization is transmitted to the module for adding a pose in a map key frame to a system state.

As a further improvement, in the present invention, the MSOC-S-IKF state update module based on map feature observation includes three parts:
a) Observation equation based on map feature points: the map feature points obtained through matching are projected to the current frame and the map key frame separately; and when the reprojection error is calculated, it is necessary to solve a Jacobian matrix of the observation equation with respect to the map points; and a left null space of the Jacobian matrix is calculated, and the left null space is multiplied by the observation equation, to eliminate an error term corresponding to the map feature point and implicitly consider uncertainty of the map feature points.
b) IKF state update based on Schmidt filtering (S): a purpose of fusing S with IKF state update is to maintain computational efficiency of the filtering algorithm while considering the uncertainty of the information about the map; and for the obtained observation equation

$$\begin{matrix}r \text{?} = - H \text{?} ϵ \text{?} + w \text{?} \\ = - [ \begin{matrix}H \text{?} & H \text{?}\end{matrix} ] [ \begin{matrix}ϵ \text{?} \\ ϵ \text{?}\end{matrix} ] + w \text{?}\end{matrix}$$

$$\text{?} \text{indicates text missing or illegible when filed}$$

state update is performed according to the following steps:

$$S \text{?} = H \text{?} P \text{?} H \text{?} + W \text{?}$$

$$K \text{?} = [ \begin{matrix}K \text{?} \\ K \text{?} \\ K \text{?}\end{matrix} ] = [ \begin{matrix}K \text{?} \\ K \text{?}\end{matrix} ] = [ \begin{matrix}P \text{?} H \text{?} + P \text{?} H \text{?} \\ P \text{?} H \text{?} + P \text{?} H \text{?}\end{matrix} ] S \text{?}$$

$$P \text{?} = P \text{?} - [ \begin{matrix}K \text{?} S \text{?} K \text{?} & K \text{?} H \text{?} [ \begin{matrix}P \text{?} \\ P \text{?}\end{matrix} ] \\ [ \begin{matrix}P \text{?} \\ P \text{?}\end{matrix} ] \text{?} H \text{?} K \text{?} & 0\end{matrix} ]$$

$$X \text{?} = [ \begin{matrix}X \text{?} \\ B \text{?}\end{matrix} ] = [ \begin{matrix}exp ( K \text{?} r \text{?} ) X \text{?} \\ B \text{?} + K \text{?} r \text{?}\end{matrix}$$

$$X \text{?} = X \text{?}$$

$$\text{?} \text{indicates text missing or illegible when filed}$$

where the subscript t represents a corresponding state quantity and covariance of the system at the current moment, t|t−1 represents a corresponding state quantity and covariance of the system before state update, r_{G}_{ₜ} is an “innovation term” derived from an observation residual,

$${H}_{{\hat{X}}_{{s}_{t}}}$$

is a Jacobian matrix of the observation equation based on the map feature points with respect to the system state and is divided into two parts,

$$H \text{?} and H \text{?}$$

$$\text{?} \text{indicates text missing or illegible when filed}$$

are Jacobians related to [symbol] and [symbol] respectively, where Xₐ represents a state part to be updated in real time and Xₙ represents a map key frame part, W_{G}_{ₜ} is a covariance matrix of observation noise w_{G}_{ₜ}, P_{t|t-1} is a covariance of the system state before state update and is divided into the following blocks according to [symbol] and [symbol] :

$${P}_{t \vert t - 1} = [ \begin{matrix}{P}_{{aa}_{t \vert t - 1}} & {P}_{{an}_{t \vert t - 1}} \\ {P}_{{na}_{t \vert t - 1}} & {P}_{{nn}_{t \vert t - 1}}\end{matrix} ]$$

[symbol] is a final updated state of the robot. [symbol] is a state of the map key frame part and remains unchanged.
c) Observability constraint (OC): to ensure the correct observability of the system and then ensure the consistency of the system, the present invention proposes an OC algorithm used for map-based positioning. Specifically, it is assumed that a right null space of an ideal observable matrix of the system is N₀ (where values corresponding to all time-invariant quantities in N₀ are corresponding initialized values). For the observation equation that projects the map feature points obtained through matching to the current frame, when the Jacobian matrix of the observation equation with respect to the state variable is calculated, if the Jacobian matrix originally calculated at the estimated value is H, after taking into account the OC, the corresponding Jacobian is to be calculated through the following equation:

$${H}^{*} = H - H {{N}_{0} ( {N}_{0}^{\cdot } {N}_{0} )}^{- 1} {N}_{0}^{\cdot }$$

by replacing H with H*, it is ensured that the system always has correct observability.

The beneficial effects of the present invention are as follows:
1) A new Lie group is proposed, where a maintained odometry-related variable and the relative transformation (namely, augmentation variable) between a local odometry reference system and a pre-built map reference system are expressed in a Lie group, such that a new IKF algorithm is obtained, thereby ensuring that the algorithm can maintain the correct observability of the system when uncertainty of a map is not taken into consideration.
2) This algorithm combines the proposed IKF with S to ensure the computational efficiency of the algorithm while considering map information, so that the calculation amount of the system only grows linearly with the increase in the amount of map information.
3) To ensure that the correct observability of the system can still be guaranteed while considering the uncertainty of map information, an OC algorithm is proposed.
4) IKF is expanded into multi-state constraint (MS) IKF to improve the estimation accuracy of the filter, and obtain the final multi-state (MS) and OC based S IKF: MSOC-S-IKF.

### BRIEF DESCRIPTION OF THE DRAWINGS

FIG. 1 is a system flowchart of a system used in an algorithm of the present invention;

FIG. 2 is a coordinate system definition diagram; and

FIG. 3 shows comparisons between calculation amounts of algorithms.

### DETAILED DESCRIPTION

The technical solution of the present invention is further described below through the specific embodiments with reference to the accompanying drawings of the specification.

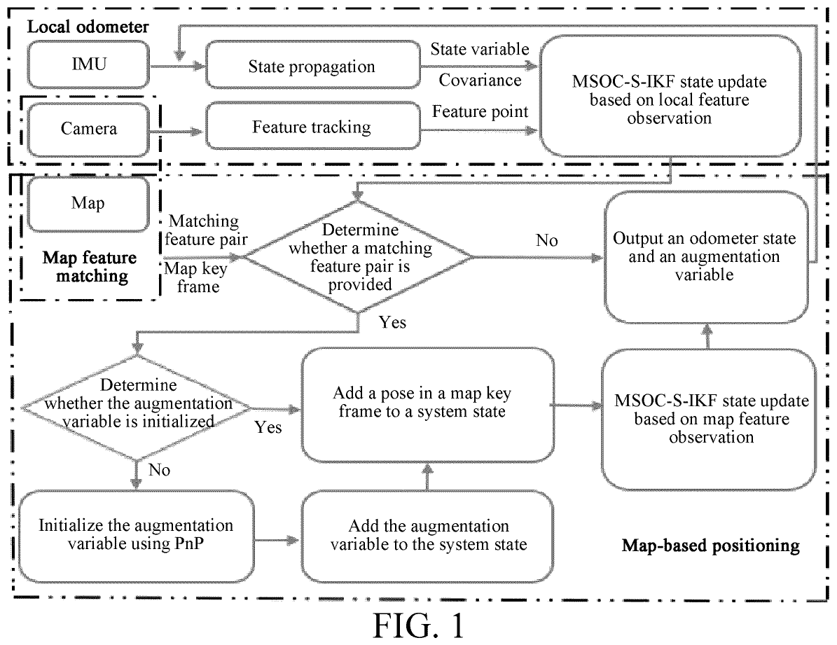

FIG. 1 is a system flowchart of a system used in an algorithm of the present invention; The system is mainly composed of three major parts: a local odometry part, a map feature matching part, and a map-based positioning part. The so-called MSOC-S-IKF is a collective name combining algorithms of such four major parts as multi-state constraint (MS), OC, S, and IKF. The four major parts are also four major innovation points of the present invention. IKF is the architecture of the entire filtering algorithm, and is applied to such two major parts as the local odometry part and the map-based positioning part. MS only acts on the local odometry part. OC and S act on the map-based positioning part.

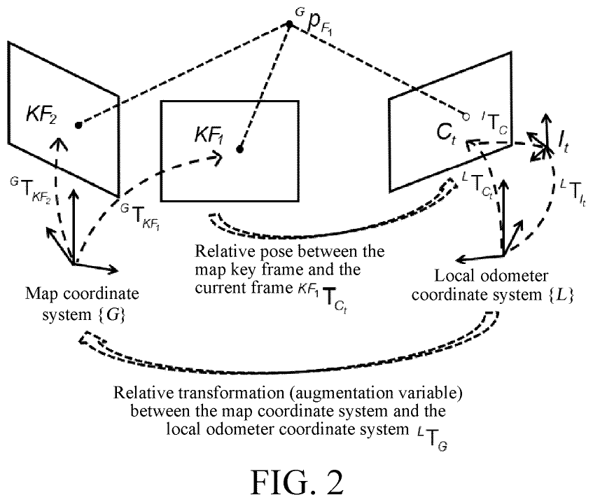

The entire system involves five types of coordinate systems, as shown in FIG. 2:
1) Local odometry coordinate system L. Robot poses obtained by a local odometry are all expressed in this system.
2) IMU/robot body coordinate system I. The angular velocity and linear velocity provided by the IMU are both expressed in this system. The subscript t represents the moment t.
3) Coordinate system C of the camera fixedly connected to the IMU.
4) Map coordinate system G. Map information is mainly composed of map key frames and map feature points. Poses of key frames and positions of feature points are all expressed in the map coordinate system.
5) Map key frame coordinate system KF.

### 1. System State Based on a New Lie Group SE_{2+K}^{M}(3)

Before introducing each module of the system, representation of state variables maintained by the system is first introduced. Different from conventional systems that represent state variables in Euclidean vector space, one of the innovation points of the present invention is to represent the state variables of the system in a new Lie group space SE_{2+K}^{M}(3). Lie group SE_{2+K}^{M}(3) is composed of Lie group SE_{2+K}(3) and Lie group SO(3), and is specifically defined as:

$${SE}_{2 + K}^{M} ( 3 ) \hat{=} \{ 𝒯 = [ \begin{matrix}{𝒯}_{1} & {0}_{( 5 + K + M ) \times ( 3 M )} \\ \text{?} & {𝒯}_{2}\end{matrix} ] , {𝒯}_{1} ∈ {SE}_{2 + K + M} ( 3 ) , {𝒯}_{2} \hat{=} diag ( {R}_{1} , … , {R}_{M} ) , \text{?} ∈ SO ( 3 ) , i = 1 , … , M \}$$

$$\text{?} \text{indicates text missing or illegible when filed}$$

where diag(.) represents a diagonal block matrix, SO(3) is defined as: SO(3) [symbol] {R∈ [symbol] RR^{T}=I,det(R)=1}, det(.) represents a determinant of a matrix, SE_{2+K}(3) is defined as:

$${SE}_{2 + K} ( 3 ) \hat{=} \{ ϒ = [ \begin{matrix}R & t \\ {0}_{( 2 + K ) \times 3} & {I}_{( 2 + K ) \times ( 2 + K )}\end{matrix} ] ∈ {ℝ}^{( 3 + 2 + K ) \times ( 3 + 2 + K )} \vert R ∈ SO ( 3 ) , t ∈ {ℝ}^{2 + K} \} .$$

a Lie algebra [symbol] (3) corresponding to the Lie group SE_{2+K}^{M}(3) is defined as:

$${𝔰𝔢}_{2 + K}^{M} ( 3 ) \hat{=} \{ {𝔏}_{𝔠 {𝔢}_{2 + K}^{M}} ( ϕ ) , ϕ = [ \begin{matrix}{θ}_{0}^{T} & {ϕ}_{1}^{T} & … & {ϕ}_{2 + K + M}^{T} & {θ}_{1}^{T} & … & {{θ}_{M}^{T} ]}^{T} ∈ {ℝ}^{9 + 3 K + 3 M} \}\end{matrix}$$

$${𝔏}_{𝔠 {𝔢}_{2 + K}^{M}} ( ϕ ) = \hat{=} [ \begin{matrix}{( {θ}_{0} )}_{\times } & {ϕ}_{1} … {ϕ}_{2 + K + M}^{T} & {0}_{3 M \times 3 M} \\ {0}_{( 2 + K + M ) \times 3} & {0}_{2 + K + M} & {0}_{( 2 + K + M ) \times ( 3 M )} \\ {0}_{3 M \times 3} & {0}_{3 M \times ( 2 + K + M )} & Θ\end{matrix} ]$$

$$Θ \hat{=} diag ( ( {θ}_{1} ) \times , … , ( {θ}_{M} ) \times ) ;$$

Based on the definitions of the Lie group SE_{2+K}^{M}(3) and the corresponding Lie algebra [symbol] (3), the present invention represents the state of the system on SE_{2+K}^{M}(3), specifically, on SE₂₊₁¹(3) (it is assumed herein that only one local feature point is considered). A state of the system at the moment t is defined as Xₜ∈SE₂₊₁¹(3)× [symbol] :

$$\text{?} = ( \text{?} , \text{?} ) ,$$

$${B}_{t} = {[ \begin{matrix}{b}_{{g}_{t}}^{T} & {b}_{{a}_{t}}^{T}\end{matrix} ]}^{T} ∈ {ℝ}^{6} ,$$

$$and$$

$$\text{?} = [ \begin{matrix}\text{?} & \text{?} & \text{?} & \text{?} & \text{?} & {0}_{3} \\ {0}_{1 \times 3} & 1 & 0 & 0 & 0 & {0}_{3} \\ {0}_{1 \times 3} & 0 & 1 & 0 & 0 & {0}_{3} \\ {0}_{1 \times 3} & 0 & 0 & 1 & 0 & {0}_{3} \\ {0}_{1 \times 3} & 0 & 0 & 0 & 1 & {0}_{3} \\ {0}_{3} & {0}_{3 \times 1} & {0}_{3 \times 1} & {0}_{3 \times 1} & {0}_{3 \times 1} & \text{?}\end{matrix} ]$$

$$\text{?} \text{indicates text missing or illegible when filed}$$

where ^{L}R_{I} represents the rotation of the robot body coordinate system I in the local odometry coordinate system L, and this variable can also rotate a three-dimensional vector in the system I to the system L. ^{L}v_{I} and ^{L}p_{I} represent the speed and position of I in L respectively. ^{L}p_{f} is the position of the local feature point f in L. ^{L}p_{G} and ^{L}R_{G} constitute the relative transformation, that is, the “augmentation variable” between the odometry reference system and the map reference system. [symbol] and [symbol] represent biases of a gyroscope and an accelerometer in the IMU.

With the definition (1) of the state of the system, it is further necessary to define an error corresponding to this state. Different from the conventional definition in Euclidean vector space, the state error of (1) is defined as:

$$\text{?} = ( \text{?} , {\hat{B}}_{t} - {B}_{t} ) \hat{=} ( \text{?} , \text{?} )$$

$$\text{?} \text{indicates text missing or illegible when filed}$$

where \hat{⋅} represents an estimator. η_{A}_{ₜ}∈SE₂₊₁¹(3), and is converted to Euclidean vector space, which has the following definition:

$${ϵ}_{t} \hat{=} {[ \begin{matrix}\text{?} & \text{?}\end{matrix} ]}^{T} \qquad ( 2 )$$

$$\text{?} \hat{=} {[ \begin{matrix}\text{?} & \text{?} & \text{?} & \text{?} & \text{?} & \text{?}\end{matrix} ]}^{T}$$

$$\text{?} = \text{?}$$

$$\text{?} = \text{?} - ( {I}_{3} + {( \text{?} )}_{\times } ) \text{?}$$

$$\text{?} = \text{?} - ( {I}_{3} + {( \text{?} )}_{\times } ) \text{?}$$

$$\text{?} = \text{?} - ( {I}_{3} + {( \text{?} )}_{\times } ) \text{?}$$

$$\text{?} = \text{?} - ( {I}_{3} + {( \text{?} )}_{\times } ) \text{?}$$

$$\text{?} = \text{?}$$

$$\text{?} = {[ {( \text{?} - \text{?} )}^{T} {( \text{?} - \text{?} )}^{T} ]}^{T}$$

$$\text{?} \text{indicates text missing or illegible when filed}$$

where [symbol] =log(\hat{R}R⁻¹) is the error vector of the rotation matrix R. log maps the Lie group SO(3) to a corresponding Lie algebra so(3). ϵₜ is defined as the error of the system state, and is called “right invariant error”.

In particular, when the uncertainty of the map needs to be considered, the relevant information of the map needs to be also added to the state of the system, so that the state of the system can be further expanded from equation (1) to:

$${X}_{t}^{*} = ( \text{?} , {B}_{t} , \text{?} ) = ( {X}_{t} , \text{?} ) \qquad ( 3 )$$

$$\text{?} \text{indicates text missing or illegible when filed}$$

where X_{M}_{ₜ} contains m map key frame poses {X_{KF}_{₁}_{,t}, . . . , X_{KF}_{ₘ}_{,t}} and n map feature point positions {^{G}p_{F}_{₁}_{,t}, . . . , ^{G}p_{F}_{ₙ}_{,t}}. Each map key frame pose { [symbol] } is composed of a rotation matrix ^{G}R_{KF}_{ᵢ}_{,t} representing an orientation and a vector ^{G}p_{KF}_{ᵢ}_{,t} representing a position, where i=1 . . . m. Correspondingly, the error [symbol] [symbol] [ [symbol] [symbol] ]^{T} of the map key frame pose is defined as:

$$\text{?} = \text{?}$$

$$\text{?} = \text{?} - ( {I}_{3} + {( \text{?} )}_{\times } ) \text{?}$$

$$\text{?} \text{indicates text missing or illegible when filed}$$

The error of the map feature point is defined as:

$${ϵ}_{{F}_{i} , t} \hat{=} {ξ}_{{F}_{i} , t} = {}_{}^{G} {\hat{p}}_{{F}_{i} , t}^{} - {}_{}^{G} {p}_{{F}_{i} , t}^{}$$

The error of the state X*ₜ of the entire system considering map uncertainty is expanded from equation (3) to:

$$\text{?} \hat{=} {[ \begin{matrix}{ϵ}_{t}^{T} & … & \text{?} & … & \text{?} & …\end{matrix} ]}^{T} \qquad ( 4 )$$

$$\text{?} \text{indicates text missing or illegible when filed}$$

Since the state of the system is defined in the Lie group SE_{2+K}^{M}(3) and has a special error definition (4), the state and variance propagation and update performed in this system state is called IKF, and a specific state propagation and update method will be introduced in the next section.

### 2. Local Odometry

As shown in FIG. 1, the input of the local odometry at the moment t is the angular velocity ωₜ and linear acceleration aₜ of the body obtained by the IMU. As mentioned before, MS and IKF are related to the local odometry part. To improve the positioning accuracy of the local odometry through MS, it is necessary to introduce an additional IMU clone variable X_{Clone}_{ₜ} and ignore a map-related variable X_{M}_{ₜ}, and then the following state definition is provided:

$${X}_{{MS}_{t}} = ( {X}_{{A}_{t}} , {B}_{t} , {X}_{{Clone}_{t}} ) \qquad ( 5 )$$

where X_{Clone}_{ₜ} contains s cloned IMU poses {X_{CP}_{ₜ}, . . . , X_{CP}_{_{t−s+1}}}, and each cloned IMU pose {X_{CP}_{ᵢ}} is composed of a rotation matrix ^{L}R_{I}_{ᵢ} representing an orientation and a vector ^{L}p_{I}_{ᵢ} representing a position. Correspondingly, the error [symbol] [symbol] [ [symbol] [symbol] ]^{T} of the cloned IMU pose is defined as:

$${ξ}_{{θ}_{{LI}_{i}}} = {\tilde{θ}}_{{LI}_{i}}$$

$${ξ}_{{p}_{{LI}_{i}}} = {}_{}^{L} {\hat{p}}_{{I}_{i}}^{} - ( {I}_{3} + {( {\tilde{θ}}_{{LI}_{i}} )}_{\times } ) {}_{}^{L} {p}_{{I}_{i}}^{}$$

Then, the error of X_{MS}_{ₜ} is:

$$\text{?} \hat{=} {[ \begin{matrix}{ϵ}_{t}^{T} & \text{?} & … & \text{?}\end{matrix} ]}^{T}$$

$$\text{?} \text{indicates text missing or illegible when filed}$$

### 1) State Propagation

The data of the IMU at the moment t is used for state propagation (prediction). Through the kinematic model of the IMU, the state prediction of the system at the moment t+1 can be obtained:

$${X}_{{MS}_{t + 1 \vert t}} = f ( {X}_{{MS}_{t}} , {ω}_{t} - {w}_{{g}_{t}} , {a}_{t} - {w}_{{a}_{t}} ) \qquad ( 6 )$$

where the system state ^{L}R_{I}_{ₜ}, ^{L}v_{I}_{ₜ}, and ^{L}p_{I}_{ₜ} are updated according to the inputted data of the IMU, and the remaining state quantities remain unchanged. The subscript t+1|t represents the predicted state at the moment t+1 obtained through the data of the IMU, that is, a state variable outputted by a state propagation module. f represents the kinematic equation of the IMU. wₐ_{ₜ} and w_{g}_{ₜ} are observation noise of the linear acceleration and the angular velocity of the IMU, and the noise constructed as zero-mean Gaussian white noise. Through the above equation, the covariance of the error state for X_{MS}_{_{t+1|t}} can be obtained, that is, the covariance outputted by the state propagation module:

$${P}_{t + 1 \vert t} = {Φ}_{t} {P}_{t \vert t} {Φ}_{t}^{\cdot } + {G}_{t} {Q}_{t \vert t} {G}_{t}^{\cdot } \qquad ( 7 )$$

where P_{t|t} and Q_{t|t} represent the state covariance and the noise covariance at the moment t respectively. Φₜ and Gₜ represent Jacobian matrices of (6) about the system state error ò_{MS}_{ₜ} and the noise wₐ_{ₜ} and w_{g}_{ₜ} respectively.

### 2) MSOC-S-IKF State Update Based on Local Feature Observation

The image of the camera is used for the observation equation part. By tracking the feature points of the image stream, that is, the feature tracking module in FIG. 1, a series of feature points {f} can be obtained, and a series of cloned historical poses {X_{CP}_{ᵢ}} of the features can be observed. For each feature f observed by X_{CP}_{ᵢ}, the following observation equation is provided:

$${}^{f} {y}_{M {S}_{i}} = h ( {X}_{C {P}_{i}} , {}^{L} {p}_{f} ) + {w}_{M {S}_{i}} \qquad ( 8 )$$

where ^{f}y_{MS}_{ᵢ} is the two-dimensional pixel coordinate of the feature f in the image, ^{L}p_{f} is the three-dimensional coordinate of f in the system L, w_{MS}_{ᵢ} is the observation noise of the image, h is the observation equation, and the equation projects ^{L}p_{f} to the image through the pose X_{CP}_{ᵢ}.

By performing first-order Taylor expansion on equation (8) in the current estimated state, the following can be obtained:

$$\text{?} \qquad ( 9 )$$

$${}^{f} {r}_{{MS}_{i}} := - {H}_{{MS}_{{x}_{i}}} {{o}^{`}}_{{MS}_{{x}_{i}}} - {}^{i} {H}_{f} {{o}^{`}}_{f} + {w}_{{MS}_{i}} \qquad ( 10 )$$

$$\text{?} \text{indicates text missing or illegible when filed}$$

where ^{f}r_{MS}_{ᵢ} represents the observation residual.

$${H}_{{MS}_{{x}_{i}}}$$

represents the Jacobian matrix of the observation equation (8) with respect to the state X_{MS}_{ₜ} (excluding the local feature point f). ⁱH_{f} is the Jacobian matrix of the observation equation (8) with respect to the feature point f.

$${ò}_{{MS}_{{x}_{i}}}$$

and ò_{f} are the “right invariant errors” of the relevant quantities.

Since a feature f can be observed by the camera corresponding to poses in X_{Clone}_{ₜ} at multiple moments (assuming that there are n moments), an observation equation (8) can be obtained for each pose X_{CP}_{ᵢ} corresponding to the camera that observes the feature f, and then (10) is obtained. By stacking the n equations (10) together, the following can be obtained:

$${}^{f} {r}_{MS} := - {H}_{{MS}_{x}} {{o}^{`}}_{{MS}_{x}} - {}^{i} {H}_{f} {{o}^{`}}_{f} + {w}_{MS} \qquad ( 11 )$$

By calculating the left null space N of H_{f}, the equation (11) can be transformed into:

$${N}^{\cdot } {}^{f} {r}_{MS} = - {N}^{\cdot } {H}_{M {S}_{x}} {{o}^{`}}_{M {S}_{x}} - {N}^{\cdot } {H}_{f} {{o}^{`}}_{f} + {N}^{\cdot } {w}_{M S} {}^{f} {r}_{MS}^{′} = - {H}_{M {S}_{x}}^{′} {{o}^{`}}_{M {S}_{x}} + {w}_{M S}^{′} \qquad ( 12 )$$

where ^{f}r′_{MS}=N^{Tf}r_{MS}, H′_{MS}_{ₓ}= [symbol] , and w′_{MS}=N^{T}w_{MS}. The IKF state update is performed through the equation (12). The specific update method of IKF is:

The input is: the observation residual r (for equation (12), there is r=^{f}r′_{MS}), the Jacobian H of the observation equation with respect to the system state (for equation (12), there is H=H′_{MS}_{ₓ}), the covariance W corresponding to the observation noise w (for equation (12), there is w=w′_{MS}), the system state \hat{X}_{MS}_{_{t|t−1}} outputted by the state propagation module, and the covariance P_{t|t-1}.

Update:

$$\text{?}$$

$$\text{?} \text{indicates text missing or illegible when filed}$$

where exp is an exponential mapping corresponding to a corresponding Lie group,

The output is: the updated system state [symbol] at the moment t and the corresponding covariance P_{t|t}.

### 3. Map Feature Matching

As shown in FIG. 1, to perform map-based positioning, it is necessary to obtain the matching relationship between the current camera and map information, that is, the map feature matching module. The pre-built map contains feature descriptors, such as BRIEF, ORB, and SIFT. Through the feature descriptors, the map feature points and map key frames obtained by the current camera through matching, that is, the matching feature pairs can be obtained. The matching information will be used in the map-based positioning algorithm.

### 4. Map-Based Positioning

This part of state update involves two innovation points, where one innovation point is the combination of S and IKF, to take the uncertainty of the map into account; and the other innovation point is the OC algorithm, which is used to ensure that the original observability of the system will not be destroyed when map-based state update is performed. The two innovation points are intended to maintain good consistency in the system and then improve the positioning accuracy of the map-based positioning algorithm. The states involved in this module are:

$$\text{?} \qquad ( 13 )$$

$$\text{?} \text{indicates text missing or illegible when filed}$$

where X_{KF}_{ₜ}={X_{KF}_{₁}_{,t}, . . . , X_{KF}_{ₘ}_{,t}} contains m map key frame poses. [symbol] [symbol] ( [symbol] [symbol] ) and [symbol] [symbol] [symbol] . Different from the state defined by equation (3), only the pose of the map key frame is added to the states, but the state of the map feature point is not added to the states, thereby saving storage and subsequent calculations.

Through the map feature matching module, the feature matching pair of the map key frame and the current frame can be obtained, as shown by the black points of KF₁ and KF₂ and the white point of Cₜ in FIG. 2. When there is a feature matching pair between the map frame and the current frame, the map frame is added to the state vector.

### 1) Initialization of Augmentation Variable ^{L}T_{G}

If the feature matching pair between the map key frame and the current frame is obtained, and the augmentation variable ^{L}T_{G} has not been initialized, the relative pose between the map frame and the current frame, that is, ^{KF}^{₁}T_{C}_{ₜ} in FIG. 2 is obtained through the PnP algorithm, and then the relative transformation ^{L}T_{G} between the map reference system and the local odometry reference system is obtained. Then, this relative pose ^{L}T_{G} is added to the state estimator.

### 2) MSOC-S-IKF State Update Based on Map Feature Observation

a) Observation equation based on map feature points: As shown in FIG. 2, the map feature points ^{G}p_{F}_{₁} obtained through matching can be separately projected to the current frame Cₜ and the map key frames KF₁ and KF₂ (generalized as KFᵢ in the following equation):

$$\begin{matrix}{}^{{F}_{j}} {y}_{{G}_{t}}^{C} = {h}^{1} ( {X}_{{A}_{t}} , {}^{G} {p}_{{F}_{j}} ) + {w}_{{C}_{t}} & ( a ) \\ {}^{{F}_{j}} {y}_{{G}_{t}}^{{KF}_{i}} = {h}^{2} ( {X}_{{KF}_{i} , t} , {}^{G} {p}_{{F}_{j}} ) + {w}_{{KF}_{i} , t} & ( b )\end{matrix} \qquad ( 14 )$$

where ^{F}^{ⱼ}y_{G}_{ₜ}^{C} and ^{F}^{ⱼ}y_{G}_{ₜ}^{KF}^{ᵢ} represent the two-dimensional pixel observations of the map feature point Fⱼ (the position in the map is ^{G}p_{F}_{ⱼ}) in the current frame C and the map key frame KFᵢ respectively. h¹ and h² are the corresponding observation projection equations respectively. [symbol] and [symbol] are the corresponding observation noises.

By performing first-order Taylor expansion on equation (14) at the estimated value, the following observation equation can be obtained:

$$\text{?} \qquad ( 15 )$$

$$\text{?} \text{indicates text missing or illegible when filed}$$

where

$$\text{?}$$

$$\text{?} \text{indicates text missing or illegible when filed}$$

and [symbol] are respectively the Jacobian matrices of the observation equation (14) with respect to [symbol] , [symbol] , and [symbol] at its estimated value.

$$\text{?}$$

$$\text{?} \text{indicates text missing or illegible when filed}$$

are the “right invariant errors” of [symbol] , [symbol] , and [symbol] respectively.

Since the feature points of the map are not added to the states, it is necessary to implicitly take the uncertainty of the map into account to ensure the consistency of the system. The specific method is: After the two observation equations in (15) are merged into one equation through a matrix stacking operation, the error term corresponding to the map feature point ^{G}p_{F}_{ⱼ} can be eliminated by calculating the left null space of H_{F}_{ⱼ} according to the operation similar to equation (12), to finally obtain the following compact observation equation expression:

$$\text{?} \qquad ( 16 )$$

$$\text{?} \text{indicates text missing or illegible when filed}$$

where r_{G}_{ₜ} is the simplified observation error,

$${H}_{{\hat{X}}_{{s}_{t}}}$$

is the Jacobian matrix of the simplified observation equation with respect to the state variable X_{S}_{ₜ}, ò_{S}_{ₜ} is the “right invariant error” of the state variable X_{S}_{ₜ}, and w_{G}_{ₜ} is the simplified observation noise.
b) IKF state update based on S

Map-based positioning needs to consider the pose of the map key frame in the state, and as the running time of the system increases, the number of map key frame pairs in the state gradually increases. Therefore, to ensure the computational efficiency of the filtering algorithm, the idea of S state update is incorporated when IKF state update is performed. Specifically, for the observation equation (16), the state update is performed according to the following steps:

$$\text{?}$$

$$\text{?} \text{indicates text missing or illegible when filed}$$

where W_{G}_{ₜ} is a covariance matrix of observation noise w_{G}_{ₜ}. P_{t|t-1} is a covariance of the system state before state update and is divided into the following blocks according to [symbol] and [symbol] :

$${P}_{t \vert t - 1} = [ \begin{matrix}{P}_{a {a}_{t \vert t - 1}} & {P}_{a {n}_{t \vert t - 1}} \\ {P}_{n {a}_{t \vert t - 1}} & {P}_{n {n}_{t \vert t - 1}}\end{matrix} ]$$

[symbol] is a final updated state of the robot. [symbol] is a state of the map key frame part and remains unchanged.
c) OC
to ensure the correct observability of the system and then ensure the consistency of the system, the present invention proposes an OC algorithm used for map-based positioning. Specifically, it is assumed that a null space of an ideal observable matrix of the system is N₀ (where values corresponding to all time-invariant quantities in N₀ are corresponding initialized values).

When the Jacobian matrix of the equation (14)-(a) with respect to the state X_{S}_{ₜ} is calculated, if the Jacobian matrix originally calculated at the estimated value is H, after taking into account the OC, the corresponding Jacobian is to be calculated through the following equation:

$${H}^{*} = H - H {{N}_{0} ( {N}_{0}^{\cdot } {N}_{0} )}^{- 1} {N}_{0}^{\cdot }$$

by replacing H with H*, it is ensured that the system always has correct observability.

### 5. Complexity of Algorithm

Through the above algorithm design, the complexity of the algorithm can be linearly related to the quantity of map key frames. Compared with the quadratic relationship of the standard EKF, the complexity is greatly simplified. In addition, the amount of stored data of the map is also greatly reduced compared with the conventional method. The specific analysis is as follows:

It is assumed that the map has m key frames and n road marks (m<<n). First, a map data storage amount is analyzed. In a conventional method, to consider the uncertainty of the map, map feature points are added to a state, rather than adding map key frames to the state in the present invention. Therefore, the complexity of the amount of map data that needs to be stored is O(n+n²)=O(n²). However, according to the algorithm design of the present invention, it is only necessary to maintain the map key frame and its covariance in the state. Therefore, the complexity of the amount of map data stored with the algorithm of the present invention is O(m+m²+n)=O(m²+n). Compared with O(n²), the storage amount is greatly reduced.

Next, the calculation complexity is analyzed. Compared with the standard EKF/IKF, in the Schmidt update algorithm used, since the auto-covariance update part related to the map variable is 0 when the state covariance is updated, the complexity of the algorithm is reduced from O(m²) to O(m). The following table lists complexity cases of different algorithms:

| | | Map element maintained | | | |
|---|---|---|---|---|---|
| Update policy for a | | in a state | | | |
| filtering algorithm | | Feature | Key | Complexity | |
| Standard | Schmidt | point | frame | Storage | Calculation |
| ✓ | | ✓ | | O(n²) | O(n²) |
| ✓ | | | ✓ | O(m² + n) | O(m²) |
| | ✓ | ✓ | | O(n²) | O(n) |
| | ✓ | | ✓ | O(m² + n) | O(m) |

The algorithm of the present invention is the last configuration in the table. It can be seen that the algorithm of the present invention has optimal storage complexity and calculation complexity.

To verify the effectiveness of the proposed MSOC-S-IKF, the pure odometry Open-VINS[1] is compared with the optimization-based algorithm VINS-Fusion[2][3], and an ablation experiment is conducted to verify the effectiveness of the innovation points proposed by the present invention. All the experiments are implemented based on a computer with Intel i7-10700@2.9 GHZ CPU and 16G RAM. MSC-S-EKF does not consider OC and IKF; MSC-EKF does not consider OC, S, and IKF; MSC-IKF does not consider OC and S. The experiment is verified on four datasets: EuRoC[4], corresponding to V102-MH05 in the following table; Kaist[5], corresponding to Urban39 in the following table; YQ[6], corresponding to YQ2-YQ4 in the following table; 4Seasons[7], corresponding to Office-Loop2 in the following table. In the table, “-” means that the algorithm cannot obtain this variable, and “ [symbol] ” means that the algorithm cannot obtain the correct positioning result on the corresponding dataset.

| | | Algorithm | | | | | |
|---|---|---|---|---|---|---|---|
| | | Open- | VINS- | MSC-S- | MSC- | MSC- | MSOC- |
| Dataset | | VINS | Fusion | EKF | EKF | IKF | S-IKF |
| V102 | Local | 0.059 | 0.120 | 0.044 | 0.062 | 0.053 | 0.036 |
| (75.89 m) | odometry | | | | | | |
| | positioning | | | | | | |
| | Map-based | — | 0.105 | 0.039 | 0.043 | 0.072 | 0.039 |
| | positioning | | | | | | |
| V103 | Local | 0.090 | 0.168 | 0.047 | 0.053 | 0.046 | 0.047 |
| (78.98 m) | odometry | | | | | | |
| | positioning | | | | | | |
| | Map-based | — | 0.145 | 0.052 | 0.063 | 0.062 | 0.057 |
| | positioning | | | | | | |
| V202 | Local | 0.065 | 0.147 | 0.056 | 0.094 | 0.062 | 0.049 |
| (86.23 m) | odometry | | | | | | |
| | positioning | | | | | | |
| | Map-based | — | 0.081 | 0.049 | 0.093 | 0.092 | 0.046 |
| | positioning | | | | | | |
| V203 | Local | 0.112 | 0.209 | 0.117 | 0.100 | 0.089 | 0.086 |
| (86.13 m) | odometry | | | | | | |
| | positioning | | | | | | |
| | Map-based | — | 0.229 | 0.150 | 0.154 | 0.133 | 0.112 |
| | positioning | | | | | | |
| MH02 | Local | 0.131 | 0.107 | 0.065 | 0.115 | 0.048 | 0.045 |
| (73.70 m) | odometry | | | | | | |
| | positioning | | | | | | |
| | Map-based | — | 0.059 | 0.030 | 0.044 | 0.045 | 0.027 |
| | positioning | | | | | | |
| MH03 | Local | 0.149 | 0.172 | 0.088 | 0.149 | 0.110 | 0.080 |
| (130.93 m) | odometry | | | | | | |
| | positioning | | | | | | |
| | Map-based | — | 0.247 | 0.081 | 0.192 | 0.188 | 0.078 |
| | positioning | | | | | | |
| MH04 | Local | 0.192 | 0.172 | 0.236 | 0.864 | 0.267 | 0.186 |
| (91.75 m) | odometry | | | | | | |
| | positioning | — | 0.428 | 0.350 | 0.728 | 0.584 | 0.255 |
| | Map-based | | | | | | |
| | positioning | | | | | | |
| MH05 | Local | 0.246 | 0.178 | 0.289 | 0.309 | 0.219 | 0.198 |
| (97.59 m) | odometry | | | | | | |
| | positioning | | | | | | |
| | Map-based | — | 0.401 | 0.526 | 0.824 | 0.508 | 0.280 |
| | positioning | | | | | | |
| Urban39 | Local | 10.491 | [symbol] | 42.873 | [symbol] | [symbol] | 2.875 |
| (10.67 km) | odometry | | | | | | |
| | positioning | | | | | | |
| | Map-based | — | [symbol] | 18.030 | [symbol] | [symbol] | 3.107 |
| | positioning | | | | | | |
| YQ2 | Local | 5.159 | [symbol] | 5.285 | [symbol] | 10.826 | 1.635 |
| (1.30 km) | odometry | | | | | | |
| | positioning | | | | | | |
| | Map-based | — | [symbol] | 1.751 | [symbol] | 20.940 | 1.504 |
| | positioning | | | | | | |
| YQ3 | Local | 4.198 | [symbol] | 3.425 | [symbol] | [symbol] | 1.348 |
| (1.28 km) | odometry | | | | | | |
| | positioning | | | | | | |
| | Map-based | — | [symbol] | 1.814 | [symbol] | [symbol] | 1.406 |
| | positioning | | | | | | |
| YQ4 | Local | 5.267 | [symbol] | 3.721 | [symbol] | [symbol] | 1.633 |
| (0.93 km) | odometry | | | | | | |
| | positioning | | | | | | |
| | Map-based | — | [symbol] | 3.384 | [symbol] | [symbol] | 2.502 |
| | positioning | | | | | | |
| Office- | Local | 12.987 | 31.389 | 33.586 | [symbol] | [symbol] | 3.666 |
| Loop2 | odometry | | | | | | |
| (3.859 km) | positioning | | | | | | |
| | Map-based | — | 19.479 | 25.698 | [symbol] | [symbol] | 4.048 |
| | positioning | | | | | | |

From the above table, it can be seen that the proposed algorithm MSOC-S-IKF can run successfully on all datasets and has the best positioning results most of the time. Compared with the pure odometry Open-VINS, MSOC-S-IKF has significantly improved positioning accuracy due to its ability to correctly fuse map information, especially for the large scene datasets Kaist, YQ, and 4seasons. Compared with the optimization-based positioning algorithm VINS-Fusion, and the ablation algorithms MSC-EKF and MSC-IKF, because the algorithms do not correctly consider the uncertainty of the map, the positioning accuracy (especially on large scene datasets) is far inferior to that of MSOC-S-IKF. On some datasets, the compared algorithms even fail to run normally. Compared with MSC-S-IKF, because the algorithms fail to maintain the correct observability of the system, the positioning results (especially the positioning result of the local odometry) are very poor.

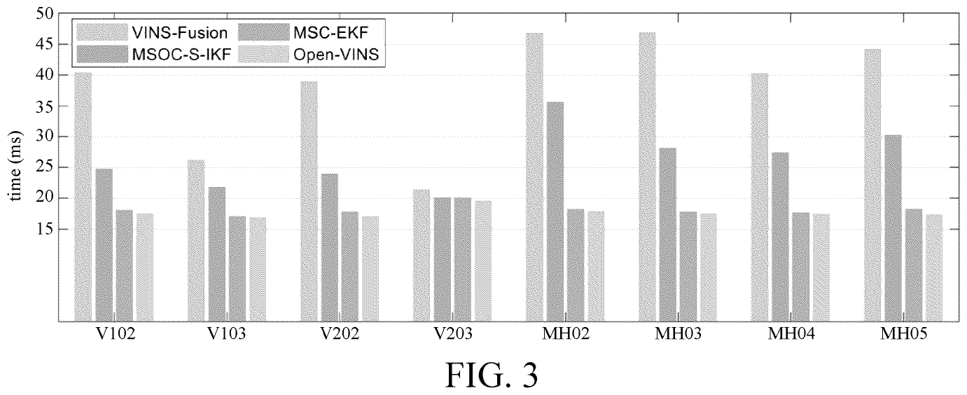

In addition, to verify the high efficiency of the algorithm of the present invention, calculation time consumption statuses of a plurality of algorithms are compared. There are four algorithms in total: Open-VINS, MSC-EKF, VINS-Fusion, and MSOC-S-IKF. The experimental results are shown in FIG. 3, where the horizontal axis represents different datasets, and the vertical axis represents calculation time consumption statuses of the algorithms (in milliseconds).

Open-VINS is pure odometry with the lowest time complexity, but has a severe drift problem (refer to the above table). The MSC-EKF algorithm does not consider the uncertainty of the map and the observability of the system, and has a very poor algorithm positioning result although the time consumption is low. VINS-Fusion is an optimization-based algorithm, which does not consider the uncertainty of the map, and has high time consumption and low positioning accuracy. The algorithm MSOC-S-IKF of the present invention has good consistency and positioning accuracy, has algorithm time consumption significantly superior to that of the optimization-based algorithm, and has good real-time performance.

Obviously, the present invention is not limited to the above embodiments, and may have many modifications. All modifications that a person of ordinary skill in the art can directly derive or associate from the disclosure of the present invention should be considered to be within the protection scope of the present invention.
[1] P. Geneva, K. Eckenhoff, W. Lee, Y. Yang and G. Huang, “OpenVINS: A Research Platform for Visual-Inertial Estimation,” 2020 IEEE International Conference on Robotics and Automation (ICRA), Paris, France, 2020, pp. 4666-4672, doi: 10.1109/ICRA40945.2020.9196524.
[2] T. Qin, P. Li and S. Shen, “VINS-Mono: A Robust and Versatile Monocular Visual-Inertial State Estimator,” in IEEE Transactions on Robotics, vol. 34, no. 4, pp. 1004-1020 August 2018, doi: 10.1109/TRO.2018.2853729.
[3] T. Qin, S. Cao, J. Pan, and S. Shen, “A general optimization-based framework for global pose estimation with multiple sensors,” arXive-prints, 2019, retrieved on Mar. 1, 2020. [Online]. Available: https://arxiv.org/abs/1901.03642v1
[4] B. Siciliano et al., “EuRoC—The Challenge Initiative for European Robotics,” ISR/Robotik 2014; 41st International Symposium on Robotics, Munich, Germany, 2014, pp. 1-7.
[5] J. Jeong, Y. Cho, Y. S. Shin, et al. “Complex urban dataset with multi-level sensors from highly diverse urban environments”, The International Journal of Robotics Research, 2019, 38(6):027836491984399.
[6] X. Ding et al., “Persistent Stereo Visual Localization on Cross-Modal Invariant Map,” in IEEE Transactions on Intelligent Transportation Systems, vol. 21, no. 11, pp. 4646-4658 November 2020, doi: 10.1109/TITS.2019.2942760.
[7] R. Wenzel, R. Wang, N. Yang, et al. (2020, September). “4Seasons: A cross-season dataset for multi-weather SLAM in autonomous driving”, In DAGM German Conference on Pattern Recognition, 2020, pp. 404-417, Springer, Cham.

What is claimed is:

1. A map-based consistent and efficient filtering algorithm for visual inertial positioning, wherein the algorithm is implemented through the following system, and the system comprises three modules:
a local odometry module, a map feature matching module, and a map-based positioning module,
wherein the local odometry module is configured to receive data of a camera and an inertial measurement unit (IMU), obtain a state of the system in a local reference system in real time, and obtain values of corresponding state variables and covariance of the values;
the map feature matching module is configured to detect a similarity between a scene observed by the camera at a current moment and a pre-built map scene, and obtain a feature matching pair of an image feature at the current moment and a map feature; and
the map-based positioning module is configured to receive an output amount of the local odometry and the feature matching pair, obtain an updated state of the local odometry and a relative transformation between the local reference system and a map reference system, and then calculate a state of a robot in the map reference system.

2. The map-based consistent and efficient filtering algorithm for visual inertial positioning according to claim 1, wherein the local odometry module comprises:
the IMU,
a state propagation module in signal connection to the IMU,
the camera,
a feature tracking module in signal connection to the camera, and
a Multi-State Observability Constraint-Schmidt-Invariant Kalman Filter (MSOC-S-IKF) state update module based on local feature observation in signal connection to the state propagation module and the feature tracking module.

3. The map-based consistent and efficient filtering algorithm for visual inertial positioning according to claim 2, wherein
the IMU is configured to provide real-time rotation angular velocity and linear acceleration for the system;
the state propagation module is configured to receive the rotation angular velocity and the linear acceleration that are provided by the IMU, propagate the state of the system from a previous moment to the current moment by using the quantities, and obtain state variables predicted at the current moment and a covariance corresponding to the state variables; and transmit signals of the obtained state variables and covariance to the MSOC-S-IKF state update module based on local feature observation;
the feature tracking module is configured to track positions of feature points in an image at the previous moment in an image at the current moment, obtain tracked feature points in the image at the current moment, and transmit signals of the obtained feature points to the MSOC-S-IKF state update module based on local feature observation; and
the MSOC-S-IKF state update module based on local feature observation is configured to calculate, through inputted feature point information combined with the inputted predicted state variables and covariance, an observation error through a reprojection error, and update the state variables and the covariance using an IKF combined with a multi-state constraint proposed by the invention.

4. The map-based consistent and efficient filtering algorithm for visual inertial positioning according to claim 3, wherein the state variables and the covariance corresponding to the state variables comprise the following variables:
1) the state of the system body at the current moment t: comprising a pose composed of a rotation matrix [symbol] and a translation vector [symbol] , and a linear velocity [symbol] ;
2) feature points [symbol] in the local reference system;
3) biases [symbol] and [symbol] of an angular velocity and a linear acceleration of an IMU sensor, to constitute a variable [symbol] =[ [symbol] [symbol] ]^{T};
4) a body pose [symbol] [symbol] { [symbol] , . . . , [symbol] } of the system at past s moments, wherein s is a size of a set sliding window, and the pose { [symbol] } is composed of a rotation matrix [symbol] representing an orientation and a vector [symbol] representing a position; and [symbol] is used for the MSOC-S-IKF state update module based on local feature observation;
5) a pose transformation ^{L}T_{G} between the local odometry reference system and the map reference system, composed of a rotation matrix ^{L}R_{G} representing an orientation and a vector ^{L}p_{G} representing a position, wherein the variable is added to the state variables through a module for initializing an augmentation variable using Perspective-n-Point (PnP) in the map-based positioning module; and
6) a pose [symbol] [symbol] { [symbol] , . . . , [symbol] } in a map key frame, wherein the pose { [symbol] } is composed of a rotation matrix [symbol] representing an orientation and a vector [symbol] representing a position, and the variable is added to the state variables through a module for adding a pose in a map key frame to a system state in the map-based positioning module.

5. The map-based consistent and efficient filtering algorithm for visual inertial positioning according to claim 4, wherein the state variables 1), 2), and 5) are represented together on a new Lie group space SE_{2+K}^{M}(3), the state variables 4) and 6) are represented in a Lie group space SE(3), the state variable 3) is represented in a Euclidean vector space, and a specific definition of SE_{2+K}^{M}(3) is:
$$\begin{matrix}{SE}_{2 + K}^{M} ( 3 ) {=}^{Δ} \{ 𝒯 = [ \begin{matrix} & {0}_{( 5 + K + M ) \times ( 3 M )} \\ {0}_{( 5 + K + M ) \times ( 3 M )}^{⊤} & \end{matrix} ] , \\ {𝒯}_{1} ∈ 𝒮 {E}_{2 + K + M} ( 3 ) , {𝒯}_{2} {=}^{Δ} diag ( {R}_{1} , … , {R}_{M} ) , \\ {R}_{i} ∈ 𝒮 O ( 3 ) , i = 1 , … , M \}\end{matrix}$$
wherein diag(.) represents a diagonal block matrix, SO(3) is defined as: SO(3) [symbol] {R∈ [symbol] RR^{T}=I,det(R)=1}, det(.) represents a determinant of a matrix, SE_{2+K}(3) is defined as:
$${SE}_{2 + K} ( 3 ) {=}^{Δ} \{ ϒ = [ \begin{matrix}R & t \\ {0}_{( 2 + K ) \times 3} & {I}_{( 2 + K ) \cdot ( 2 + K )}\end{matrix} ] ∈ R ∈ SO ( 3 ) , t ∈$$
a Lie algebra [symbol] (3) corresponding to the Lie group SE_{2+K}^{M}(3) is defined as:
$${𝔰𝔢}_{2 + K}^{M} ( 3 ) {=}^{Δ} \{ {𝔏}_{{𝔰𝔢}_{2 + K}^{M}} ( ϕ ) , ϕ = [ \begin{matrix}{θ}_{0}^{⊤} & {ϕ}_{1}^{⊤} & … & {ϕ}_{2 + K + M}^{⊤} & {θ}_{1}^{⊤} & … & {{θ}_{M}^{⊤} ]}^{⊤}\end{matrix} ∈ \}$$
$${𝔏}_{{𝔰𝔢}_{2 + K}^{M}} ( ϕ ) = {ϕ}^{\text{?}} {=}^{Δ} [ \begin{matrix}{( {θ}_{0} )}_{\times } & {ϕ}_{1} … {ϕ}_{2 + K + M} & {0}_{3 \times 3 M} \\ {0}_{( 2 + K + M ) \times 3} & {0}_{2 + K + M} & {0}_{( 2 + K + M ) \times ( 3 M )} \\ {0}_{3 M \times 3} & {0}_{3 M \times ( 2 + K + M )} & Θ\end{matrix} ] \begin{matrix}Θ {=}^{Δ} diag ( {( {θ}_{1} )}_{\times } & , … , & {( {θ}_{M} )}_{\times } )\end{matrix} ;$$
$$\text{?} \text{indicates text missing or illegible when filed}$$
based on the definitions of SE_{2+K}^{M}(3) and [symbol] (3), states composed of the state variables 1), 2), and 5) are represented as:
$${X}_{\text{?}} = [ \begin{matrix}{}_{}^{L} {R}_{\text{?}}^{} & {}_{}^{L} {v}_{\text{?}}^{} & {}_{}^{L} {p}_{\text{?}}^{} & {}_{}^{L} {p}_{\text{?}}^{} & {}_{}^{L} {p}_{\text{?}}^{} & {0}_{3} \\ {0}_{1 \times 3} & 1 & 0 & 0 & 0 & {0}_{3} \\ {0}_{1 \times 3} & 0 & 1 & 0 & 0 & {0}_{3} \\ {0}_{1 \times 3} & 0 & 0 & 1 & 0 & {0}_{3} \\ {0}_{1 \times 3} & 0 & 0 & 0 & 1 & {0}_{3} \\ {0}_{3} & {0}_{3 \times 1} & {0}_{3 \times 1} & {0}_{3 \times 1} & {0}_{3 \times 1} & {}_{}^{L} {R}_{{G}_{t}}^{}\end{matrix} ]$$
$$\text{?} \text{indicates text missing or illegible when filed}$$
corresponding state errors are defined as:
$$\begin{matrix}{ξ}_{{θ}_{\text{?}}} = {\tilde{θ}}_{{LI}_{\text{?}}} \\ {ξ}_{{v}_{\text{?}}} = {}_{}^{L} {\hat{v}}_{\text{?}}^{} - ( {I}_{3} + {( {\tilde{θ}}_{{LI}_{\text{?}}} )}_{\times } ) {}_{}^{L} {v}_{\text{?}}^{} \\ {ξ}_{{p}_{\text{?}}} = {}_{}^{L} {\hat{p}}_{\text{?}}^{} - ( {I}_{3} + {( {\tilde{θ}}_{{LI}_{\text{?}}} )}_{\times } ) {}_{}^{L} {p}_{\text{?}}^{} \\ {ξ}_{{p}_{\text{?}}} = {}_{}^{L} {\hat{p}}_{\text{?}}^{} - ( {I}_{3} + {( {\tilde{θ}}_{{LI}_{\text{?}}} )}_{\times } ) {}_{}^{L} {p}_{\text{?}}^{} \\ {ξ}_{{p}_{\text{?}}} = {}_{}^{L} {\hat{p}}_{\text{?}}^{} - ( {I}_{3} + {( {\tilde{θ}}_{{LI}_{\text{?}}} )}_{\times } ) {}_{}^{L} {p}_{\text{?}}^{} \\ {ξ}_{{θ}_{\text{?}}} = {\tilde{θ}}_{{LG}_{\text{?}}}\end{matrix}$$
$$\text{?} \text{indicates text missing or illegible when filed}$$
an error of the state 3) is defined as:
$${ξ}_{{B}_{i}} = {[ \begin{matrix}{( {\hat{b}}_{{g}_{t}} - {b}_{{g}_{i}} )}^{⊤} & {( {\hat{b}}_{{a}_{t}} - {b}_{{a}_{t}} )}^{⊤}\end{matrix} ]}^{⊤}$$
an error of a pose { [symbol] } corresponding to the state 4) is defined as:
$$\begin{matrix}{ξ}_{{θ}_{\text{?}}} = {\tilde{θ}}_{{LI}_{\text{?}}} \\ {ξ}_{{p}_{\text{?}}} = {}_{}^{L} {\hat{p}}_{\text{?}}^{} - ( {I}_{3} + {( {\tilde{θ}}_{{LI}_{\text{?}}} )}_{\times } ) {}_{}^{L} {p}_{\text{?}}^{}\end{matrix}$$
$$\text{?} \text{indicates text missing or illegible when filed}$$
an error of a pose { [symbol] } corresponding to the state 6) is defined as:
$${ξ}_{{θ}_{{KF}_{i} , t}} = {\tilde{θ}}_{{KF}_{i} , t}$$
$${ξ}_{{p}_{{KF}_{i} , t}} = {}^{G} {\hat{p}}_{{KF}_{i} , t} - ( {I}_{3} + {( {\tilde{θ}}_{{KF}_{i} , t} )}_{\times } ) {}_{}^{G} {p}_{{KF}_{i} , t}^{}$$
θ in the above equations represents an error of a corresponding rotation matrix R, and is defined as: θ=log(RR⁻¹), and log maps the Lie group SO(3) to a corresponding Lie algebra so(3); and \hat{⋅} in the above equations represents an estimated value; and
when the state propagation module and the MSOC-S-IKF state update module based on local feature observation solve a Jacobian matrix of a motion equation or an observation equation with respect to a state variable error, the state variable error is the error defined above.

6. The map-based consistent and efficient filtering algorithm for visual inertial positioning according to claim 2, wherein the MSOC-S-IKF state update module based on local feature observation completes state update through the following equations:
$$\begin{matrix}{S}_{\text{?}} = {H}_{\text{?}} {P}_{\text{?}} {H}_{i}^{⊤} + {W}_{i} \\ {K}_{\text{?}} {=}^{Δ} [ \begin{matrix}{K}_{{X}_{\text{?}}} \\ {K}_{{B}_{\text{?}}} \\ {K}_{{X}_{\text{?}}}\end{matrix} ] = {P}_{\text{?}} {H}_{i}^{⊤} {S}_{\text{?}}^{- 1} \\ {X}_{\text{?}} = [ \begin{matrix}{X}_{{A}_{\text{?}}} \\ {B}_{\text{?}} \\ {X}_{\text{?}}\end{matrix} ] [ \begin{matrix}exp ( {K}_{{X}_{\text{?}}} {r}_{\text{?}} ) {X}_{\text{?}} \\ {B}_{\text{?}} + {K}_{{B}_{\text{?}}} {r}_{\text{?}} \\ exp ( {K}_{{X}_{\text{?}}} {r}_{\text{?}} ) {X}_{\text{?}}\end{matrix} ] \\ {P}_{\text{?}} = {P}_{\text{?}} - {K}_{\text{?}} {H}_{\text{?}} {P}_{\text{?}}\end{matrix}$$
$$\text{?} \text{indicates text missing or illegible when filed}$$
wherein [symbol] is a Jacobian matrix of an observation equation with respect to a state error, [symbol] is a variance of observation noise, [symbol] is an “innovation term” derived from an observation residual, exp( ) is an exponential mapping corresponding to a corresponding Lie group, [symbol] is a variance of an output of the state propagation module, and [symbol] and [symbol] are respectively state variables and a corresponding covariance updated by the MSOC-S-IKF state update module based on local feature observation.

7. The map-based consistent and efficient filtering algorithm for visual inertial positioning according to claim 1, wherein the map feature matching module is configured to obtain, through information about the current camera and a map, map feature points obtained by the current camera through matching and a map key frame in which the map feature points are observable, namely, a feature pair and a map key frame that match, wherein signals of the feature pair and the map key frame that match are transmitted to the map-based positioning module.

8. The map-based consistent and efficient filtering algorithm for visual inertial positioning according to claim 7, wherein the map-based positioning module comprises the following modules:
a module for determining whether there is a feature matching pair,
a module for determining whether an augmentation variable is initialized,
the module for initializing an augmentation variable using PnP,
a module for adding an augmentation variable to a system state, the module for adding a pose in a map key frame to a system state,
an MSOC-S-IKF state update module based on map feature observation, and
a module for outputting an odometry state and an augmentation variable;
the module for determining whether there is a feature matching pair is configured to receive information from the map feature matching module, and determine whether a map key frame and a corresponding feature matching pair that match a current frame are provided, wherein if there is an output, indicating that there is a feature matching pair between the current frame and a map frame, a subsequent map-based positioning-related process is performed; or if there is no output, indicating that there is no feature matching pair between the current frame and a map frame, an odometry state and an augmentation variable are outputted directly without performing MSOC-S-IKF state update based on map feature observation;
the module for determining whether an augmentation variable is initialized is configured to determine whether a relative pose (namely, an augmentation variable) between the map reference system and the local odometry reference system has been initialized, wherein if the map feature matching module has outputted a feature pair and a map key frame that match and the augmentation variable has been initialized, the map key frame is added directly to the system state, and the feature pair and the map key frame that match are further used for the subsequent MSOC-S-IKF state update module based on map feature observation; or if the map feature matching module has outputted a feature pair and a map key frame that match, but the augmentation variable has not been initialized, the feature pair and the map key frame that match are used for the module for initializing an augmentation variable using PnP;
the module for initializing an augmentation variable using PnP is configured to calculate a relative pose between the map reference system and the local odometry reference system, solve a relative pose between the map key frame and the current frame of the camera by receiving the feature pair and the map key frame that match outputted by the map feature matching module and using a PnP algorithm, and solve the relative pose between the local odometry reference system and the map reference system by using the pose in the map key frame and a pose of the robot in the local odometry reference system at the current moment, to obtain a value of the augmentation variable and a corresponding covariance and complete the initialization;
the module for adding an augmentation variable to a system state is configured to add the augmentation variable to variables maintained by the system, wherein the augmentation variable is updatable in real time through the subsequent MSOC-S-IKF state update module based on map feature observation;
the module for adding a pose in a map key frame to a system state is configured to add the pose in the map key frame and the covariance to the state variables of the system and the covariance of the system, to naturally take into account uncertainty of the map and improve consistency of the system; and
the MSOC-S-IKF state update module based on map feature observation uses the information about the map to update the state variables of the system while satisfying 1) considering the uncertainty of the map, 2) maintaining correct observability of the system, and 3) requiring a low amount of calculations for the system, to obtain a more precise odometry state and augmentation variable and then obtain a more precise pose of the robot in the map reference system.

9. The map-based consistent and efficient filtering algorithm for visual inertial positioning according to claim 8, wherein the MSOC-S-IKF state update module based on map feature observation comprises three parts:
a) observation equation based on map feature points: the map feature points obtained through matching are projected to the current frame and the map key frame separately; and when the reprojection error is calculated, it is necessary to solve a Jacobian matrix of the observation equation with respect to the map points; and a left null space of the Jacobian matrix is calculated, and the left null space is multiplied by the observation equation, to eliminate an error term corresponding to the map feature point and implicitly consider uncertainty of the map feature points;
b) IKF state update based on Schmidt filtering (S): a purpose of fusing S with IKF state update is to maintain computational efficiency of the filtering algorithm while considering the uncertainty of the information about the map; and for the obtained observation equation
$$\begin{matrix}{r}_{{G}_{\text{?}}} = - {H}_{{\dot{X}}_{\text{?}}} {ϵ}_{{S}_{\text{?}}} + {w}_{{G}_{\text{?}}} \\ = - [ \begin{matrix}{H}_{{X}_{\text{?}}} & {H}_{{X}_{\text{?}}} ] [ \begin{matrix}{ϵ}_{\text{?}} \\ {ϵ}_{\text{?}}\end{matrix} ] + {w}_{{G}_{\text{?}}}\end{matrix}\end{matrix}$$
$$\text{?} \text{indicates text missing or illegible when filed}$$
state update is performed according to the following steps:
$$\begin{matrix}{S}_{\text{?}} = {H}_{{X}_{\text{?}}} {P}_{\text{?}} {H}_{{X}_{\text{?}}}^{⊤} + {W}_{{G}_{\text{?}}} \\ {K}_{{S}_{\text{?}}} = [ \begin{matrix}{K}_{{X}_{\text{?}}} \\ {K}_{{B}_{\text{?}}} \\ {K}_{{X}_{\text{?}}}\end{matrix} ] = [ \begin{matrix}{K}_{{X}_{\text{?}}} \\ {K}_{{X}_{\text{?}}}\end{matrix} ] = [ \begin{matrix}{P}_{\text{?}} {H}_{\dot{X}}^{⊤} + {P}_{\text{?}} {H}_{\dot{X}}^{⊤} \\ {P}_{\text{?}} {H}_{\dot{X}}^{⊤} + {P}_{\text{?}} {H}_{\dot{X}}^{⊤}\end{matrix} ] {S}_{\text{?}}^{- 1} \\ {P}_{\text{?}} = {P}_{\text{?}} - [ \begin{matrix}{K}_{{X}_{\text{?}}} & {K}_{{X}_{\text{?}}} {H}_{X} [ \begin{matrix}{P}_{\text{?}} \\ {P}_{\text{?}}\end{matrix} ] \\ {[ \begin{matrix}{P}_{\text{?}} \\ {P}_{\text{?}}\end{matrix} ]}^{⊤} {H}_{X}^{⊤} {K}_{X}^{⊤} & 0\end{matrix} ] \\ {X}_{\text{?}} = [ \begin{matrix}{X}_{{A}_{\text{?}}} \\ {B}_{\text{?}}\end{matrix} ] [ \begin{matrix}exp ( {K}_{{X}_{\text{?}}} {r}_{\text{?}} ) {X}_{\text{?}} \\ {B}_{\text{?}} + {K}_{{B}_{\text{?}}} {r}_{\text{?}}\end{matrix} ] \\ {X}_{\text{?}} = {X}_{\text{?}}\end{matrix}$$
$$\text{?} \text{indicates text missing or illegible when filed}$$
wherein the subscript t represents a corresponding state quantity and covariance of the system at the current moment, t|t−1 represents a corresponding state quantity and covariance of the system before state update, [symbol] is an “innovation term” derived from an observation residual,
$${H}_{{\hat{X}}_{\text{?}}}$$
$$\text{?} \text{indicates text missing or illegible when filed}$$
is a Jacobian matrix of the observation equation based on the map feature points with respect to the system state and is divided into two parts, [symbol] and [symbol] are Jacobians related to [symbol] and [symbol] respectively, wherein [symbol] represents a state part to be updated in real time and [symbol] represents a map key frame part, [symbol] is a covariance matrix of observation noise [symbol] , [symbol] is a covariance of the system state before state update and is divided into the following blocks according to [symbol] and [symbol] :
$${P}_{\text{?}} = [ \begin{matrix}{P}_{\text{?}} & {P}_{\text{?}} \\ {P}_{\text{?}} & {P}_{\text{?}}\end{matrix} ]$$
$$\text{?} \text{indicates text missing or illegible when filed}$$ [symbol]
is a final updated state of the robot, and [symbol] is a state of the map key frame part and remains unchanged; and
c) observability constraint (OC): to ensure the correct observability of the system and then ensure the consistency of the system, an OC algorithm is used for map-based positioning; it is assumed that a right null space of an ideal observable matrix of the system is [symbol] wherein values corresponding to all time-invariant quantities in [symbol] are corresponding initialized values; and for the observation equation that projects the map feature points obtained through matching to the current frame, when the Jacobian matrix of the observation equation with respect to the state variable is calculated, if the Jacobian matrix originally calculated at the estimated value is H, after taking into account the observability constraint, the corresponding Jacobian is to be calculated through the following equation:
$${H}^{*} = H - H {( )}^{- 1} {\text{?}}^{}$$
$$\text{?} \text{indicates text missing or illegible when filed}$$
by replacing H with H*, it is ensured that the system always has correct observability.
